(19) United States
(12) Patent Application Publication
(10) Pub. No.: US 2002/0073168 A1
(43) Pub. Date: Jun. 13, 2002

(54) Multimedia messaging linked to physical objects

(75) Inventors: Kristine Riley, Menlo Park, CA (US); Guy Tiphane, Atherton, CA (US)

Correspondence Address: Paul C. Haughey, TOWNSEND and TOWNSEND and CREW LLP, Two Embarcadero Center, 8th Floor, San Francisco, CA, 94111-3834, US

(73) Assignee: Logitech Europe S.A.

(21) Appl. No.: 09/733,512

(22) Filed: Dec. 7, 2000

(51) Int. Cl. G06F 15/16

(52) U.S. Cl. 709/217; 709/231

(57) ABSTRACT

A method, and corresponding apparatus, for allowing a composer to create a presentation on a website. An identification link to the website is embedded on a media (other than a CD or floppy disk). The media is then attached to the physical object which the composer also wishes to deliver to the recipient. The combination is then delivered to the recipient, who can observe the physical object, and use the media through an appropriate reader to access the website with the identification on the media. The user can then view the presentation on the website.

### BACKGROUND OF THE INVENTION

The present invention relates to a method for transferring a multimedia presentation from a composer to a recipient via a physical object.

Many methods exist for exchanging information between people. In a basic format, paper documents can be sent from a composer to a user. Alternately, a composer may send a computer disk which the user can then load onto his/her computer. Products are shipped with computer disks (CDs or floppy disks) which can include programming, manuals, and URL links within the manual or program to a website for technical support.

Another method of sending data is via e-mail which can enclose attached documents or can have an embedded URL for accessing a website the composer wishes the recipient to see.

A number of peripherals have also been developed for aiding in the accessing of computer information, however received. Keyboards have been built with fingerprint readers for ensuring that the user is an authorized user of the particular computer. Keyboards have also been manufactured with card readers, usually to enable a user to swipe a credit card to facilitate on-line shopping.

Often, however, a composer may desire to provide a multimedia computer presentation to user, but also wants to provide a physical object in the form of a hard copy of paper or some other object, such as a piece of art, book, etc. It would be desirable to provide a method for facilitating the delivery of both types of information to a user in a simple manner.

### SUMMARY OF THE INVENTION

The present invention provides a method, and corresponding apparatus, for allowing a composer to create a presentation on a website. An identification link to the website is embedded on a media (other than a CD or floppy disk). The media is then attached to the physical object which the composer also wishes to deliver to the recipient. The combination is then delivered to the recipient, who can observe the physical object, and use the media through an appropriate reader to access the website with the identification on the media. The user can then view the presentation on the website.

In one embodiment, the media is a paper clip with an identification code embedded in it. The identification code is associated with a particular page of a website that is assigned to the composer. The recipient can take the paper clip and put it through an appropriate reader, which will automatically activate the indicated website page. The identification embedded on the paper clip may be simply the URL for the website and the composer's page on that website.

In other embodiments, the media can be a Post-It® Note which is attached to the documents or other physical object. Alternately, the media could be a computer-readable card. Any of the objects might be readable by a standard card reader, such as by swiping the paper clip, Post-It or card through the card reader. Alternately, a specialized reader can be used.

The ID can be pre-encoded in the device before it is shipped to the composer with a pre-assigned ID. Alternately, the composer can be authorized to create the ID using the composer's computer. For example, the ID could be in the form of a barcode which is printed on the Post-It, card or other physical media. Alternately, the ID could be data which is loaded into a SmartCard through a SmartCard reader.

For a further understanding of the nature and advantages of the invention, reference should be made to the following description taken in conjunction with the accompanying drawings.

### BRIEF DESCRIPTION OF THE DRAWINGS

FIG. 1 is a diagram illustrating the steps in the use of the present invention.

FIG. 2 is a block diagram of a keyboard and computer system implementing the present invention.

FIG. 3 is a diagram of one embodiment of the contents of an ID code imbedded in the physical object.

### DESCRIPTION OF THE SPECIFIC EMBODIMENTS

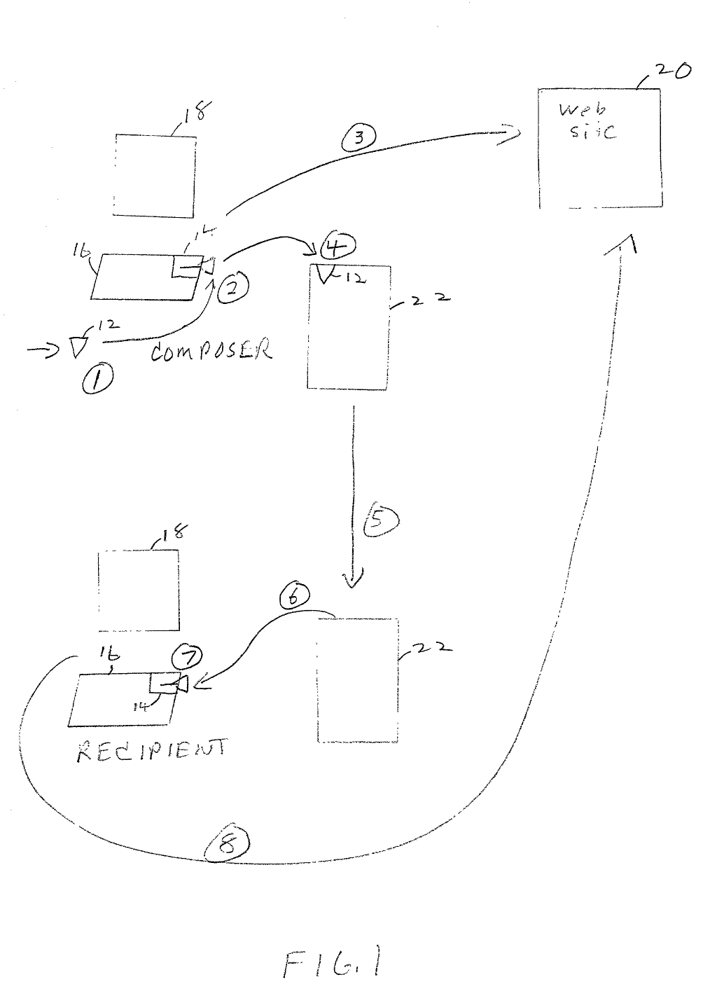

FIG. 1 illustrates the method of an embodiment of the invention. In step 1, a paper clip 12 with an assigned ID code embedded in it is shipped to the composer. The composer in step 2 swipes the paper clip through a card reader 14 in a keyboard 16. Through the composer's computer 18, a website 20 is accessed in step 3. The user creates or downloads to the website page assigned by the ID an appropriate presentation.

In step 4, paper clip 12 is attached to a physical object, such as document 22. In step 5, this document is sent to a recipient. The recipient removes the paper clip from document 22 (step 6) and swipes it through the recipient's card reader. The ID code will uniquely be recognized to activate a program for launching a browser to access website 20 in step 8.

Instead of a card reader, a specialized reader designed to accept the paper clip or other object can be used. Alternately, the card reader 14 could be a SmartCard reader, which allows data to be written onto the card in addition to reading the card. The composer could initially access a website, be assigned an ID electronically, and then write that ID code onto a blank paper clip or card.

Alternately, the ID code could be printed on a standard printer onto labels, Post-Its, etc. The printed ID could be in the form of a barcode, for example. The reader used by the recipient could then be a barcode reader associated with the computer.

The presentation loaded by the user onto the website could be a video recording, an audio recording, electronic documents including word processing documents; spreadsheets and graphics files; digitized photographs; text; links to other websites; or any other multimedia content. In one embodiment, the owner of website 20 assigns pages of that website with corresponding IDs to corresponding composers. Alternately, multiple websites could be used, or a combination of multiple websites each with multiple pages could be used.

The composer could buy a box of paper clips that all have the same identification. This would allow access to a single user presentation by multiple recipients. For example, a composer could choose to present a resume with a paper clip and additional presentations of his/her work would be available through the paper clip accessing the website page. A corporation could choose to have the same identification for all of its paper clips, all leading to the corporate website.

Alternately, a user could buy a box of clips each having different, unique identifications. Upon initial use, each clip would lead to composing a new presentation. The user could, however, choose to have a group of clips go to the same presentation. This could be done either by duplicating the presentation in multiple website pages corresponding to the different IDs, or by modifying or adding to the ID to include a pointer to the same web site page.

The media which the ID is embedded in or encoded on could be Post-It notes with an embedded chip or code written on it, or business cards, or books, or products with packaging containing the code, or objects containing the code, or art pieces containing the code.

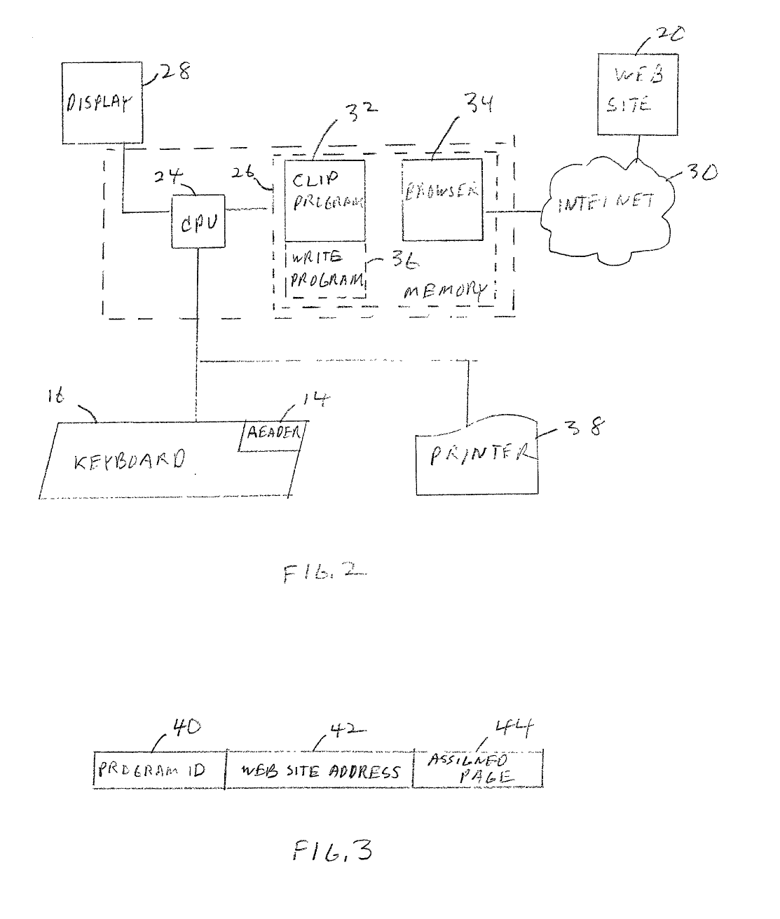

FIG. 2 is a block diagram of a keyboard and computer system for implementing the invention. Shown in FIG. 2 is keyboard 16 with a card/clip reader 14. Alternately, a scanner could be used in place of card reader 14. The keyboard is connected to a computer 18. Computer 18 includes a CPU 24 which connects to a memory 26 and a display 28. The computer also connects through Internet 30 to website 20.

Computer memory 26 can contain a clip program 32 for providing the functions of the invention. In response to a received ID, clip program 22 can cause a browser 34 to be launched to allow access of the website. Clip program 32 can optionally contain a write program 36 for writing the ID through reader 14, or for printing the ID through a printer 38 or appropriate medium.

In one embodiment, the ID code could be the form of a barcode which is written on labels inserted into printer 38. These labels can be adhesive on one side, for attachment to papers, or other physical objects to be sent to the recipient. The recipient could then scan the barcode on the object without removing the label from the object.

In one embodiment, the clip program contains both portions for composing and receiving IDs associated with the website. The clip program would recognize whether a particular ID is designated for a composer or a recipient. An ID designated for a composer may include within it some identification of the composer, whether the ID is in a paper clip or other media shipped through the mail to the composer, or downloaded to the composer's computer. The lack of a match could be used to indicate that the computer user is a recipient, causing the activation of the recipient's steps in the program, which allow the accessing of the indicated web page without a write capability, allowing read only. The composer would be provided access with the write capability to modify and load things onto the web page.

FIG. 3 is a diagram of one embodiment of the contents of an ID code. A first portion 40 of the code could indicate the clip program ID. This could be used, for example, by the card reader or scanner software to recognize that this is not a card for credit card access, but rather one that should be forwarded to the clip program. A second portion 42 of the ID can be the website address of website 20. It can either be the actual URL or an encoded version which allows access to the URL stored in clip program 32 or accessible through clip program 32 in browser 34 or elsewhere in memory 26. A last part of the ID can be a section 44 which contains a particular assigned page of the website for the composer to create or load the composer's presentation.

As will be understood by those of skill in the art, the present invention may be embodied in other specific forms without departing from the essential characteristics thereof. Accordingly, the foregoing description is intended to be illustrative, but not limiting, of the scope of the invention which is set forth in the following claims.

What is claimed is:

1. A method comprising:
creating a presentation on a web site;
imbedding an identification linked to said web site on a media other than a computer readable disk;
attaching said media to a physical object;
delivering said physical object to a recipient; and
reading said identification and accessing said web site.

2. The method of claim 1 wherein said media is a paper clip.

3. The method of claim 1 wherein said media is a paper with an adhesive side for attaching to said physical object.

4. The method of claim 1 wherein said media is a card.

5. The method of claim 1 wherein said reading is performed with a smart card reader.

6. The method of claim 1 wherein said reading is performed with a bar code scanner.

7. A computer readable media comprising computer readable instructions for:
detecting an activating input from a reader;
reading an identification code corresponding to a web site;
identifying said identification code as a composer identification code associated with said computer readable instructions or as a recipient identification code;
for a composer identification code, initiating an accessing of said web site for the loading of a presentation on said web site;
for a user identification code, accessing a web site identified by said identification code for reading of said web site.

8. A method comprising:
providing a media to a user;
accessing a web site and providing to said web site information from said media;
providing presentation space on said web site associated with information on said media;
providing a presentation from said user to said web site for storage in said presentation space; and
retrieving said presentation from said presentation space upon subsequent provision to said web site of said information on said media.
